(19) United States
(12) Patent Application Publication
(10) Pub. No.: US 2014/0365440 A1
(43) Pub. Date: Dec. 11, 2014

(54) HIGH AVAILABILITY SNAPSHOT CORE

(71) Applicant: Avaya Inc., Basking Ridge, NJ (US)

(72) Inventor: Robert C. Steiner, Broomfield, CO (US)

(21) Appl. No.: 13/910,881

(22) Filed: Jun. 5, 2013

(51) Int. Cl. G06F 17/30

(52) U.S. Cl. CPC G06F 17/30088
USPC 707/639

(57) ABSTRACT

A high availability contact center is described along with various methods and mechanisms for administering the same. The contact center proposed herein enables snapshots of one instance of a work assignment engine to be transmitted to another server instance where they can be loaded and used as a backup to the original work assignment engine.

### FIELD OF THE DISCLOSURE

The present disclosure is generally directed toward communications and more specifically toward contact centers.

### BACKGROUND

Contact centers rely on components to always be working, as communication is key to the business. Typically, businesses that run contact centers want a high level of reliability. To achieve what is known as High Availability (HA), communication service providers generally sell two sets of servers and server applications. One set is the active set, and the other is the standby set. If any active application fails, the standby applications, running in hot standby mode, recognize this failure and take over processing for the active set.

HA systems need to be robust, have the ability to synchronize, have the ability to stay functional and/or recover if the active/standby fails, receive and store backups, patches, and upgrades, and be able to perform diagnostics. As HA systems become prolific, there is a significant need to improve communication, efficiency, and recovery abilities in such systems.

### SUMMARY

In many systems, if a context (e.g., an object used to store thread-specific information about an execution environment) is lost upon system failure, a new context has to be started. Often backups are too large and dedicated pipes must be built to send, synchronize, or store snapshots that are huge. There is a need to improve communication, efficiency, and recovery abilities in an HA system.

It is, therefore, one aspect of the present disclosure to provide a system that utilizes one or more file codecs and snapshot imaging for a remote system (e.g., High Availability/geographical redundancy server) so that there is preservation of thread and context, objects can be written to disk, backups can be sent and synchronized in a reasonably-sized package, and more sophisticated diagnostics become available.

One aspect of the present disclosure is to provide a snapshot core. In some embodiments, a snapshot of a work assignment engine in a contact center is taken and then loaded into a separate work assignment engine. The snapshot core can also use different codecs to perform different functions. As some non-limiting examples: a compression codec could be used to conserve bandwidth between the servers on which the work assignment engines are located as these servers may be in different locations and connected via a distributed communications network (e.g., Internet). The snapshot of the work assignment engine could also be sent to a remote system using the compression codec. Other codecs could be used to do file writes. Some types of codecs that may be employed by the snapshot core include system-to-system codecs, which are capable of breaking up the snapshot into frames for sending via TCP/IP. A corresponding codec at the receiving remote server can be configured to reconstruct the snapshot frames to piece together the entirety of the snapshot. Additionally, engine tools can be used to see what was going on during the snapshot and for troubleshooting purposes. This snapshot can also easily be loaded onto a lab system for testing and diagnostics. The snapshot can also be saved onto a disk.

Another aspect of the present disclosure is to vectorize the data obtained from the snapshot into one or more tables. These vectorized snapshots can be used to synchronize one server with the other server, thereby enabling synchronized remote work assignment engines.

Another aspect of the present disclosure is to provide the ability to rewrite a work assignment engine, partially or in its entirety, to a previously failed server. In some embodiments, the work assignment engine may be configured to operate in a system called an interchange. The work assignment engine may comprise a thread, which is the smallest sequence of programmed instructions that can be managed independently by an operating system scheduler. In most cases, a thread is contained inside a process. Multiple threads can exist within the same process and share resources such as memory, while different processes do not necessarily share these resources. In particular, the threads of a process may share the latter's instructions (e.g., the process's code) and its context (e.g., the values that the process's variables reference at any given moment).

With this solution, if the work assignment engine thread dies, the interchange container becomes aware of the death. The interchange can be configured to keep a reference to the context, create a log, start up a new thread (e.g., a different object), and give the context to the new thread. The new thread can then use the context received from the interchange to start running where the other context left off. In some embodiments, the new context may begin running immediately while in other embodiments the new context may only start running after running a validation routine to validate the image and fix any issues.

In accordance with at least some embodiments of the present disclosure, a method is provided which generally comprises:

obtaining a snapshot of a work assignment engine operating or being configured to operate in a contacting center

compressing, with a compression codec, the snapshot or a portion thereof into a compressed snapshot;

packetizing the compressed snapshot to create a packetized snapshot; and

transmitting the packetized snapshot to a remote server, the packetized snapshot being transmitted over an IP-based communications network.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting a communication system in accordance with embodiments of the present disclosure;

FIG. 3 is a block diagram depicting two remotely-located servers in accordance with embodiments of the present disclosure;

FIG. 4 is a flow diagram depicting a snapshot method in accordance with embodiments of the present disclosure;

FIG. 5 is a flow diagram depicting a troubleshooting method in accordance with embodiments of the present disclosure;

FIG. 6 is a block diagram depicting a server in accordance with embodiments of the present disclosure; and

FIG. 7 is a flow diagram depicting a thread handoff method in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

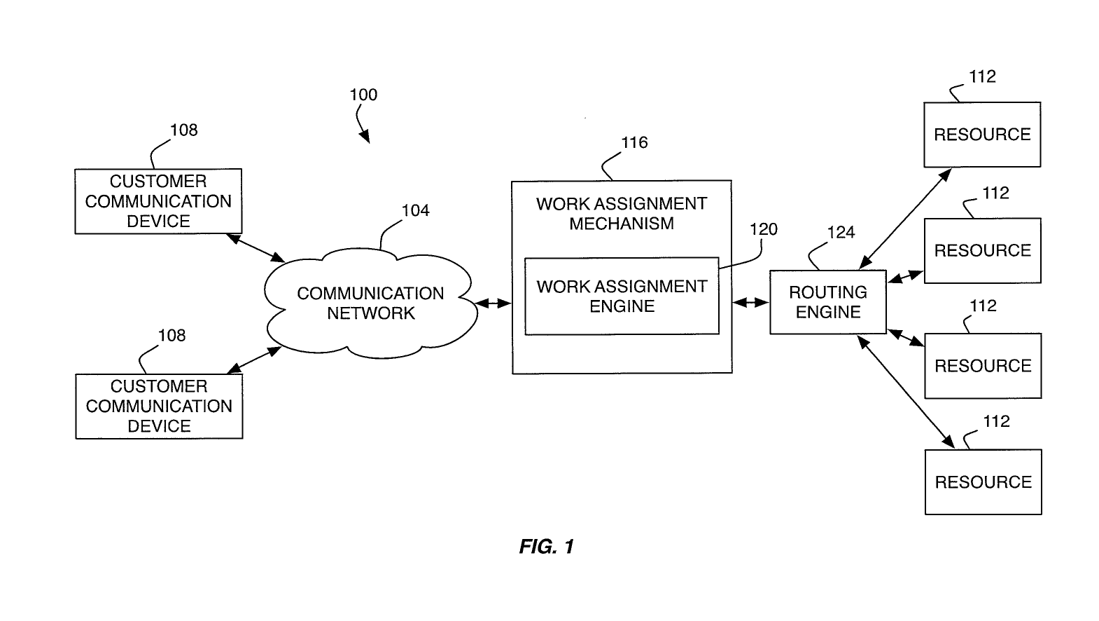

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 124 to connect the communication device 108 which initiated the communication with the assigned resource 112.

Although the routing engine 124 is depicted as being separate from the work assignment mechanism 116, the routing engine 124 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 124. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

More specifically, the work assignment engine 120 can determine which of the plurality of processing resources 112 is qualified and/or eligible to receive the work item and further determine which of the plurality of processing resources 112 is best suited to handle the processing needs of the work item. In situations of work item surplus, the work assignment engine 120 can also make the opposite determination (i.e., determine optimal assignment of a work item resource to a resource). In some embodiments, the work assignment engine 120 is configured to achieve true one-to-one matching by utilizing bitmaps/tables and other data structures.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

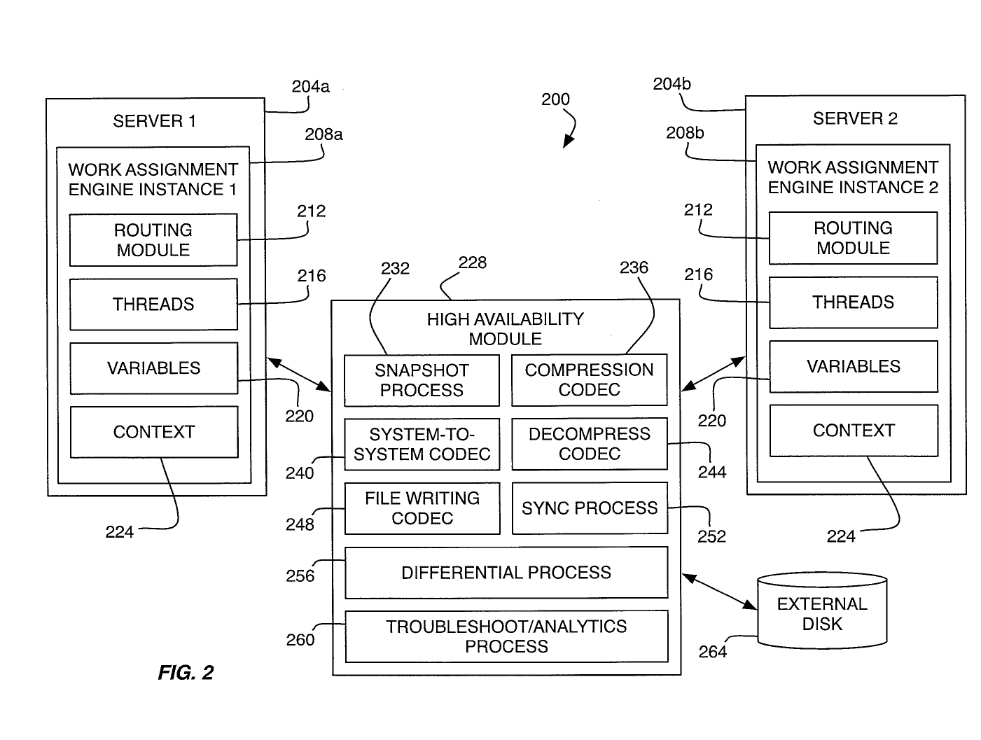

With reference now to FIG. 2, a high availability system 200 is depicted in accordance with at least some embodiments of the present disclosure. The system 200 is depicted as including a first server instance 204a and a second server instance 204b. Both servers 204a, 204b may be configured to execute a work assignment engine 208a, 208b, respectively. Each work assignment engine 208a, 208b may comprise a routing module 212 or logic, threads 216, variables 220, and context 224.

A high availability module 228 may be provided to create snapshots of one work assignment engine instance (e.g., work assignment engine 208a) and copy that snapshot to the other server (e.g., second server 204b), thereby enabling the servers 204a, 204b to maintain synchronization and a high availability architecture. In some embodiments, the high availability module 228 may comprise a number of components to enable its functionality. Examples of such components and processes include, without limitation, a snapshot process 232, a compression codec 236, a system-to-system codec 240, a decompression codec 244, a file-writing codec 248, a synchronization process 252, a differential process 256, and a troubleshooting/analytics process 260. In some embodiments, the high availability module 228 may also be configured to write some or all of a work assignment engine snapshot to an external disk 264.

Referring back to the servers 204a, 204b, it should be appreciated that the servers 204a, 204b may be located in physically different locations and may be separated by a communications network 104, for example. Furthermore, the work assignment mechanism 116 may correspond to or include a server 204a, 204b. Moreover, the work assignment engine instances 208a, 208b may be similar or identical to the work assignment engine 120. Specifically, the work assignment engine instances 208a, 208b may be configured to analyze contacts in a contact center and make work assignment decisions for such contacts. The routing module 212, in some embodiments, may correspond to the logic or algorithms that are executed by the work assignment engines 208a, 208b to make work assignment decisions. In some embodiments, the routing module 212 may correspond to a set of instructions stored in a non-transitory computer-readable memory that are executed by a processor. When executed, the routing module 212 may be configured to make a plurality of work assignment decisions within the contact center for one or more contacts and one or more resources 112 within the contact center.

The threads 216 may correspond to the smallest sequence of programmed instructions within the work assignment engine instance 208a, 208b that can be managed independently by an operating system scheduler. A thread 216 is a light-weight process. The implementation of threads 216 and processes differs from one operating system to another, but in most cases, a thread 216 is contained inside a process. Multiple threads 216 can exist within the same process and share resources such as memory, while different processes do not share these resources. In particular, the threads 216 of a process share the latter's instructions (its code) and its context 224 (e.g., the values that the thread's 216 variables 220 reference at any given moment).

On a single processor, multithreading generally occurs by time-division multiplexing (as in multitasking): the processor switches between different threads. This context switching generally happens frequently enough that the user perceives the threads or tasks as running at the same time. On a multiprocessor or multi-core system, threads 216 can be truly concurrent, with every processor or core executing a separate thread 216 simultaneously.

As referenced above, the variables 220 may correspond to any class, parameter, or variable referenced by a thread 216 and used by the routing module 212 to make a work assignment decision. Variables 220 may relate to current status of resources 112, current status of a work item waiting for assignment to a resource 112, Key Performance Indices (KPIs) for one or more entities within the contact center, an amount of time elapsed since a certain event, current wait time for a work item, current idle time for a resource 112, and so on.

The context 224 of the work assignment engine 208a, 208b may correspond to the values of a thread's 216 variables 220 at a given time. Thus, as time progresses, the context 224 of the work assignment engine 208a, 208b will evolve. Specifically, the context 224 correspond to the work assignment engine's 208a, 208b current view of the contact center state and its resources 112. In some embodiments, the context 224 may correspond to an object used to store thread-specific information about an execution environment. When maintaining two synchronized work assignment engine instances 208a, 208b, it is important to maintain a synchronization between the contexts 224 of the two instances 208a, 208b, thereby enabling one instance to pick up where another instance leaves off.

As noted above, the high availability module 228 may be configured to capture one or more snapshots of one work assignment engine instance (e.g., instance 208a) with a snapshot process 232. The snapshot process 232 may include executable-instructions that enable the high availability module 228 to obtain a snapshot of the entire work assignment engine instance 208a, including its routing module instructions 212 (e.g., as compiled instructions), its threads 216, its variables 220, and its context 224. The snapshot process 232 may be configured to obtain these snapshots periodically (e.g., hourly, daily, weekly, monthly, etc.), systematically (e.g., in response to certain thresholds or events occurring), and/or in response to manual inputs by a system administrator. In other words, the snapshot process 232 may be configured to obtain snapshots in the form of binary objects and/or system copies that are representative of the entire work assignment engine instance 208 at a given point in time. The snapshot may be stored in local memory (e.g., server memory) or it may be stored in an external disk 264.

In addition to providing the ability to obtain a snapshot, the high availability module 228 may employ its compression codec 236 to compress the snapshot obtained by the snapshot process 232. In some embodiments, the compression codec 236 may be configured to compress the snapshot with a lossless compression codec, for example, Context tree weighting (CTW) method, Burrows-Wheeler transform, LZW, PPMd, etc. Any type of compression scheme can be used to prepare the snapshot for transmission across a bandwidth-constrained communication network 104. As other examples, the snapshots may be compressed one or more of, the Lempel-Ziv (LZ) compression method, DEFLATE as a variation on LZ optimized for decompression speed and compression ratio, DEFLATE as used in PKZIP, Gzip and PNG, LZW (Lempel-Ziv-Welch), and/or the LZR (Lempel-Ziv-Renau) algorithm, which serves as the basis for the Zip method. The compression codec 236 is configured to reduce the size of the snapshot so that it is easier to transmit across a communication network 104.

The system-to-system codec 240 may be provided to break up a snapshot into frames for sending via TCP/IP. In particular, the system-to-system codec 240 may break up a snapshot that has either been compressed by the compression codec 236 or which has not bee compressed. The system-to-system codec 240 may prepare the snapshot for transmission across an IP-based communication network, such as the Internet, and/or any other type of packet-based network.

The decompression codec 244 may comprise the functionality to decompress a snapshot at the receiving end of a communication network 104. The decompression codec 244 may comprise the functionality to decompress the snapshot that was compressed by the compression code 236. In some embodiments, the compression codec 236 may be configured to compress and decompress the snapshot.

The file-writing codec 248 may be configured to write a snapshot to an external disk 264 and/or another server instance 204b. In some embodiments, the file-writing codec 248 is configured to write the decompressed snapshot to the second server 204b, thereby enabling a backup to exist for the first server 204a. Specifically, all of the work assignment engine instance 208a may be duplicated with the file-writing codec 248 at the second server 204b, thereby creating the second work assignment engine instance 208b. Even more specifically, the high availability module 228 may write a copy of the snapshot that includes the routing module 212, its threads 216, its variables 220, and its context 224, to the second server 204b.

The synchronization process 252 may be configured to ensure that the contexts 224 at each server 204a, 204b are properly synchronized. More specifically, the synchronization process 252 may be configured to monitor the current context 224 of one work assignment engine instance 208a and ensure that the current context 224 of the other work assignment engine instance 208b is the same. If the synchronization process 252 determines that the two contexts 224 are not synchronized, then the synchronization process 252 may invoke the snapshot process 232 to obtain a new snapshot of the work assignment engine 208a for transfer to the other server 204b.

The differential process 256 may be configured to reduce the amount of data transmitted from one server 204a to another 204b, or vice versa. Specifically, the differential process 256 may be configured to monitor the snapshots obtained by the snapshot process 232 and mark a particular snapshot as a key snapshot. The differential process 256 may then monitor changes or deltas in each subsequent snapshot as compared to the key snapshot. Once the key snapshot has been transmitted from one server 204a to the other server 204b, it may only be necessary to transmit the deltas along with a reference to the key snapshot. Thus, as changes are made to the key snapshot, only the deltas to the key snapshot are transmitted to the backup server 204b. This enables the high availability module 228 to send less than all of the entire snapshot every time a snapshot is obtained. More particularly, this enables snapshots to be shared on a more regular basis (e.g., every second, every minute, etc.), since only differences between the last snapshot or a key snapshot are shared over the communication network 104.

The troubleshooting/analytics process 260 may be configured to obtain an entire binary object of the work assignment engine 208a (e.g., via a snapshot) and analyze the entire object to determine if a thread 216 failed and/or if any bugs exist within the work assignment engine 208a, 208b. In some embodiments, the troubleshooting/analytics process 260 may also be configured to write an entire snapshot to the external disk 264 and analyze all of its threads 216, variables 220, and context 224 after the work assignment engine 208a has failed to determine what, if anything, led to the failure of the work assignment engine 208a. If, however, the work assignment engine 208a failed due to the hardware of the server 204a failing, then there may be no need to analyze the snapshot of the failed work assignment engine instance 208a.

Although the high availability module 228 is depicted as being located on a single server, it should be appreciated that some components of the high availability module 228 may be executed at or near the first server 204a whereas other components of the high availability module 228 may be executed at or near the second server 204b. Specifically, the snapshot process 232, compression codec 236, and/or system-to-system codec 240 may be executed on server 204a or a server physically proximate thereto. On the other hand, the decompression codec 244, file-writing codec 248, and other components may be executed on server 204b or a server physically proximate thereto. It should also be appreciated that a full instance of the high availability module 228 may reside at both the sending and receiving side of the system 200. Specifically, a first instance of the high availability module 228 may reside at or near the first server 204a while a second instance of the high availability module 228 may reside at or near the second server 204b.

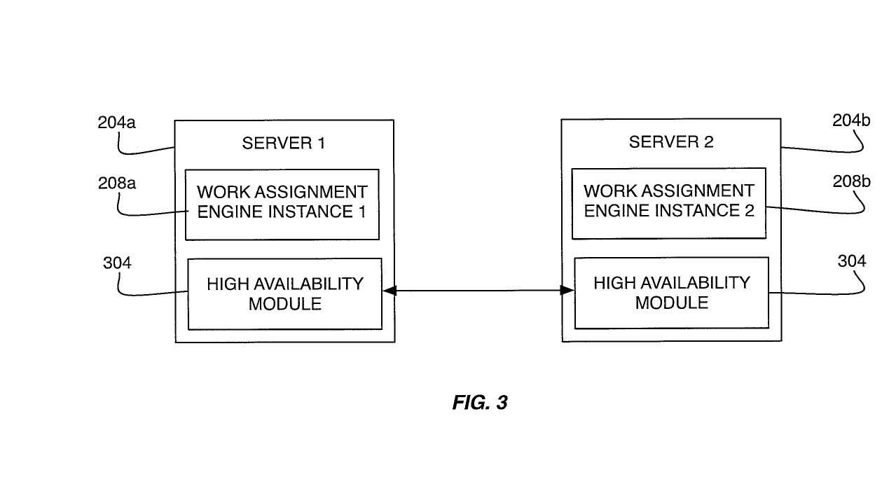

With reference now to FIG. 3, additional details of a high availability system 200 will be described in accordance with embodiments of the present disclosure. The system depicted in FIG. 3 shows that some or all of the high availability module 304, which may be similar or identical to the high availability module 228, may be executed on the first server 204a and/or the second server 204b. Moreover, FIG. 3 depicts how the high availability modules 304 enable the snapshots of one work assignment engine instance 208a to be shared from one server 204a across a communication network 104 to another server 204b, thereby enabling the creation and continued maintenance of a second work assignment engine instance 208b.

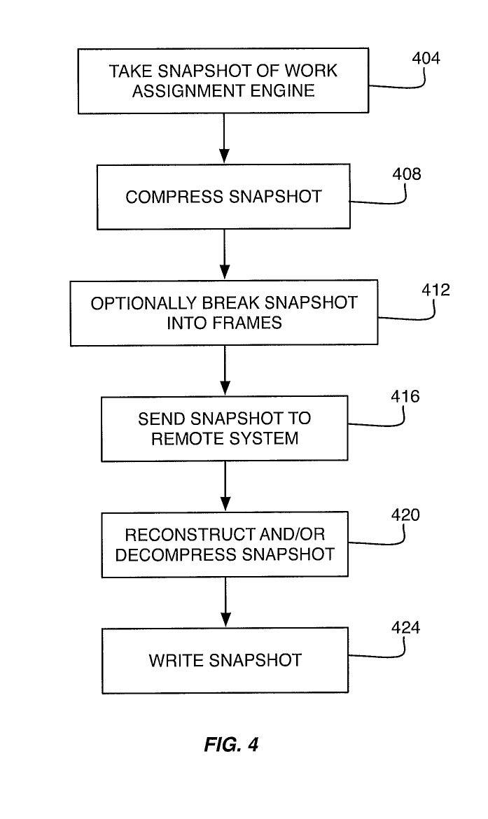

FIG. 4 depicts a first backup method in accordance with at least some embodiments of the present disclosure. The method begins with the snapshot process 232 obtaining a snapshot of the work assignment engine 208 and all of its components (step 404). In particular, the work assignment engine 208a and its components (e.g., routing module 212, threads 216, variables 220, and context 224) may have an image thereof obtained by the snapshot process 232. The snapshot obtained by the snapshot process 232 may then be compressed by the compression codec 236 (step 408). Compression of the snapshot may enable the file size of the snapshot to be reduced as compared to the original snapshot.

The method continues with the system-to-system codec 240 preparing the snapshot (or a compressed version thereof) for transmission across a communication network. Specifically, the system-to-system codec 240 may break the snapshot into one or more frames (step 412) and/or packetize the snapshot. The packetized snapshot (or its frames) may then be transmitted across the communication network to the remote system (e.g., second server 204b) (step 416).

At the remote system, the snapshot may be reconstructed with the assistance of the decompression codec 244 and/or another version of the system-to-system codec 240 (step 420). The reconstructed snapshot may then be written to the remote system (e.g., to the second server 204b) by the file writing codec 248 (step 424).

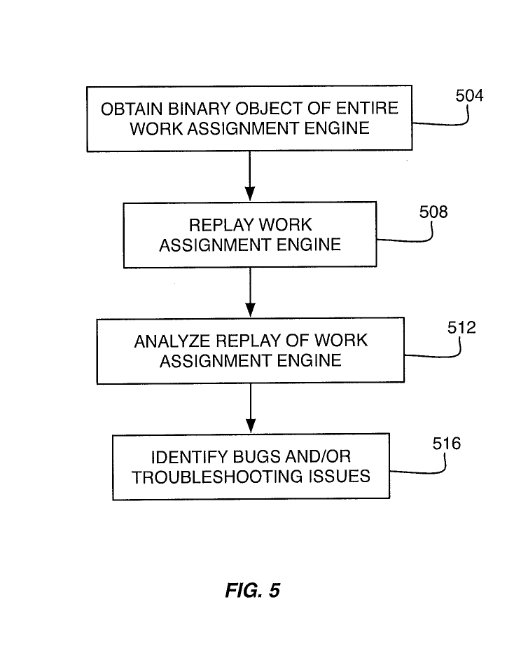

With reference now to FIG. 5, a troubleshooting and/or analysis method will be described in accordance with at least some embodiments of the present disclosure. The method begins with the creation of a binary object that represents the entire work assignment engine 208a at a certain point in time (step 504). The binary object may correspond to a newly-obtained snapshot or to a snapshot obtained from memory.

The troubleshooting/analytics process 260 may then replay the work assignment engine 208a up to the point where failure was detected (step 508). During replay of the work assignment engine behavior, the troubleshooting/analytics process 260 may analyze the work assignment engine 208a and its components (e.g., threads 216, variables 220, and context 224) to determine if some anomalous event occurred during execution (step 512). Based on the analysis of the work assignment engine 208a replay, the troubleshooting/analytics process 260 may identify one or more bugs and/or determine if any troubleshooting issues exist that require further in-depth analysis (step 516).

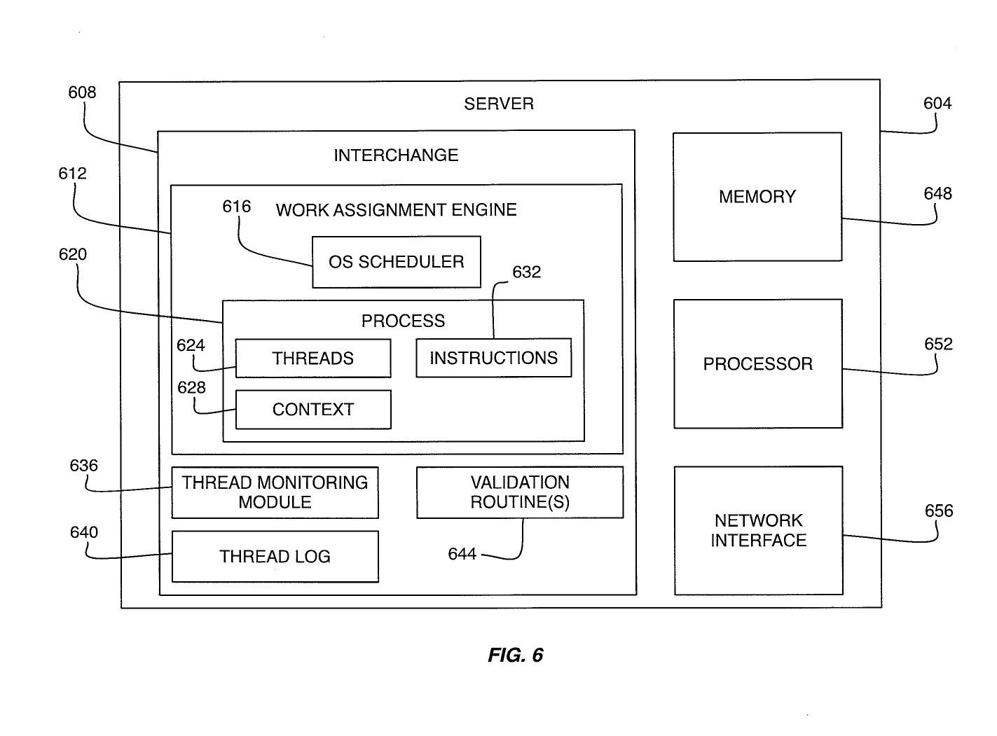

With reference now to FIG. 6, details of a server 604 will be described in accordance with at least some embodiments of the present disclosure. The server 604 may include an interchange 608 that comprises a work assignment engine 612, a thread monitoring module 636, a thread log 640, and one or more validation routine(s) 644. The server 604 may also comprise memory 648 (e.g., RAM, ROM, flash, or a combination thereof), a processor 652 (e.g., microprocessor, etc.), and a network interface 656 (e.g., wired and/or wireless network interface card, driver, or the like). In some embodiments, the work assignment engine 612 may be similar or identical to the work assignment engines 120, 208a, and/or 208b.

The interchange 612, in accordance with at least some embodiments, corresponds to a space within the server 604 within which the work assignment engine 612 is executed or in which one work assignment engine instance 208a is communicated from one server 204a to another server 204b. Thus, the interchange 612 may be executed on a high availability module 228 or some other server acting as an interchange between remote systems or between an application and some other systems. In some embodiments, the interchange 612 corresponds to an execution context or container for applications like, the work assignment engine, and provides memory, threading, logging, and communications support services to those applications.

Components within the work assignment engine 612 may include, without limitation, an Operating System (OS) scheduler 616 and one or more processes 620, each of which may comprise one or more threads 624, context 628, and instructions 632. The OS scheduler 616 may correspond to the process that schedules the execution of threads 624 by the processor 652 and the threads 624 may be created as a result of the work assignment engine 612 and its processes 620 being executed by the processor 652. The context 628 may correspond to or describe variables and their current values at a given point in time. The threads 624 may use and update variables during execution, thereby updating the context 628.

During execution of the work assignment engine 612, the thread monitoring module 636 may analyze the performance of threads 624 to detect if a failure is beginning to occur or has already occurred. If the interchange 612 becomes aware of a thread 624 failure, then the interchange 612 can maintain a reference to the failed thread within its thread log 640 and start a new thread (e.g., a different object) by providing the old context to the new thread. The new thread 624 may, in some embodiments, be validated by the validation routine(s) 640 before becoming active. In this way, the interchange 608 can detect and replace failed threads before their failure adversely affects the entire operation of the work assignment engine 612.

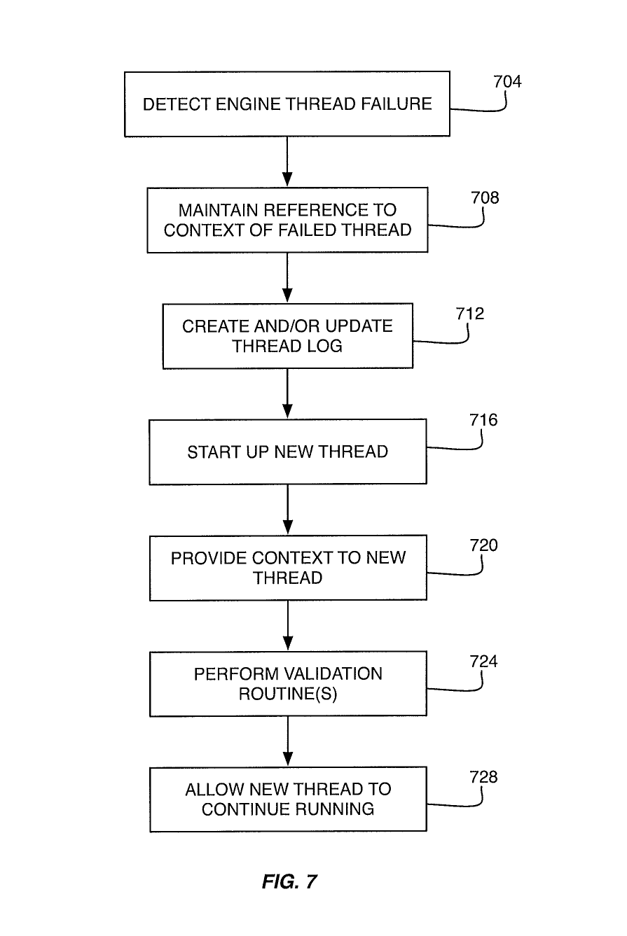

With reference now to FIG. 7, additional details of a thread failure detection method will be described in accordance with at least some embodiments of the present disclosure. The method begins with the interchange 608 detecting the failure of one or more threads 624 within the work assignment engine 612 (step 704). Upon detecting a failed thread, the interchange 608 maintains a reference to the failed thread 624 by storing information about the failed thread 624 in the thread log 640 and maintaining reference to the failed thread's context 628 (steps 708 and 712).

The interchange 608 then starts up a new thread 624 (step 716) and provides the new thread 624 with context 628 from the failed thread 624 (step 720). If necessary, the interchange 608 further performs one or more validation routines 644 on the new thread 624 before allowing it to run (step 724). Once the new thread has been properly validated, the image has been validated, and any issues have been fixed, the new thread is allowed to begin running where the previous thread failed (step 728).

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
obtaining a snapshot of a work assignment engine operating or being configured to operate in a contacting center;
compressing, with a compression codec, the snapshot or a portion thereof into a compressed snapshot;
packetizing the compressed snapshot to create a packetized snapshot; and
transmitting the packetized snapshot to a remote server, the packetized snapshot being transmitted over an IP-based communications network.

2. The method of claim 1, wherein the snapshot of the work assignment engine comprises instructions for executing the work assignment engine at a first instance of time.

3. The method of claim 2, wherein the snapshot further includes threads, variables, and a context at the first instance of time.

4. The method of claim 3, wherein the threads correspond to a smallest sequence of programmed instructions that can be managed independently by an operating system scheduler, wherein the threads are contained within a process, wherein the threads are within a common process and share the context, which corresponds to values of the variables at the first instance of time.

5. The method of claim 1, further comprising:
receiving the packetized snapshot and de-packetizing the packetized snapshot;
decompressing the de-packetized snapshot; and
writing the de-packetized snapshot to at least one of memory and an external disk.

6. The method of claim 5, wherein the snapshot is written to a second server that is remote from a first server from which the snapshot was obtained and wherein the first and second servers are separated by a communications network.

7. The method of claim 1, further comprising:
analyzing threads of the work assignment engine for failure;
detecting that at least one thread has failed;
maintaining a reference to context of the at least one failed thread;
starting a new thread;
providing the context from the at least one failed thread to the new thread; and
allowing the new thread to begin running with the context.

8. The method of claim 7, wherein the new thread is validated prior to the allowing step.

9. A non-transitory computer readable medium having stored thereon instructions that cause a computing system to execute a method, the instructions comprising:
instructions configured to obtain a snapshot of a work assignment engine operating or being configured to operate in a contacting center;
instructions configured to compress the snapshot or a portion thereof into a compressed snapshot;
instructions configured to packetize the compressed snapshot to create a packetized snapshot; and
instructions configured to transmit the packetized snapshot to a remote server, the packetized snapshot being transmitted over an IP-based communications network.

10. The computer readable medium of claim 9, the snapshot of the work assignment engine comprises instructions for executing the work assignment engine at a first instance of time.

11. The computer readable medium of claim 10, the snapshot further includes threads, variables, and a context at the first instance of time.

12. The computer readable medium of claim 11, wherein the threads correspond to a smallest sequence of programmed instructions that can be managed independently by an operating system scheduler, wherein the threads are contained within a process, wherein the threads are within a common process and share the context, which corresponds to values of the variables at the first instance of time.

13. The computer readable medium of claim 9, further comprising:
instructions configured to analyze threads of the work assignment engine for failure;
instructions configured to detect that at least one thread has failed;
instructions configured to maintain a reference to context of the at least one failed thread;
instructions configured to start a new thread;
instructions configured to provide the context from the at least one failed thread to the new thread; and
instructions configured to allow the new thread to begin running with the context.

14. The computer readable medium of claim 13, wherein the new thread is validated prior to the allowing step.

15. A contact center, comprising:
a first server executing a first instance of a work assignment engine;
a second server located in a physically remote location from the first server and connected to the first server via a packet-based communications network; and
a high availability module in communication with the first server and the second server, the high availability module comprising a snapshot process configured to obtain a snapshot of the first instance of the work assignment engine at a first point in time, the high availability module further comprising a system-to-system codec configured to transmit the snapshot of the first instance of the work assignment engine to the second server, thereby enabling the second server to execute a second instance of the work assignment engine in substantial synchronization with the first instance of the work assignment engine.

16. The contact center of claim 15, wherein the high availability module is executed on both the first server and the second server.

17. The contact center of claim 15, wherein the high availability module further comprises a troubleshooting/analytics process configured to analyze the snapshot for failed threads.

18. The contact center of claim 15, wherein the work assignment engine comprises instructions for executing the work assignment engine, threads, variables, and context for the variables.

19. The contact center of claim 15, wherein the first server and second server are separated by at least ten miles and connected by the Internet.

20. The contact center of claim 15, wherein the second instance of the work assignment engine is synchronized with the first instance of the work assignment engine due to a sharing of context between the first server and second server.
